(19) United States
(12) Patent Application Publication
(10) Pub. No.: US 2012/0306161 A1
(43) Pub. Date: Dec. 6, 2012

(54) MULTI-SEGMENT SEAL RETAINER FOR ROTATING SHAFTS

(75) Inventor: Benjamin W. Floan, Andover, MN (US)

(73) Assignee: Crown Iron Works Company

(21) Appl. No.: 13/480,003

(22) Filed: May 24, 2012

Related U.S. Application Data
(60) Provisional application No. 61/491,677, filed on May 31, 2011.

(51) Int. Cl. F16J 15/16

(52) U.S. Cl. 277/572

(57) ABSTRACT

A retainer assembly for a seal encircling a shaft to prevent migration along the shaft, has at least two rings that encircle the shaft. A first ring is fastened to the wall and encircles the shaft to form an annular recess surrounding the periphery of the seal. A second ring encircles the shaft with outside and inside diameters allowing at least a portion of the second ring to fit into the annular recess between the first ring and the seal. A plurality of fasteners attach to the first ring and are external to the second ring. Each fastener engages a peripheral portion of the second ring to press the second ring toward the wall. In a preferred embodiment, the retainer has inner, middle, and outer rings that allow retaining of two seal sections.

### CROSS-REFERENCE TO RELATED APPLICATIONS

This is a regular application filed under 35 U.S.C. §111(a) claiming priority, under 35 U.S.C. §119(e)(1), of provisional application Ser. No. 61/491,677, previously filed May 31, 2011, under 35 U.S.C. §111(b).

### BACKGROUND

Pumps and other types of processing devices often have rotating shafts that penetrate the device housing to an internal space that contains fluids or particles undergoing processing. Such devices frequently employ seals that surround the shafts to prevent the fluids or particles from migrating during use from the internal space along the shaft to outside the housing. These seals, being subjected to constant rubbing during use, deteriorate over time, and require replacing. Large shafts used because of high torque requirements, have seals and retainers for them that are large and expensive, and difficult to replace properly.

The seals and their retainers are attached to the housing itself. Such shafts have bearings that usually are external to the device housing. Thus, these large shafts and the bearings that support them are difficult if not impossible to remove in order to replace a seamless or unitary seal and housing. To simplify replacement, the seals and their retainers usually have a segmented or multi-part structure that allows disassembly and assembly on the shaft.

In some scenarios, especially with large shafts, lip seals in a back-to-back arrangement provide an improved sealing function. This requires that the retainer for these seals accommodate a large cross-section width, i.e. axial length, for the seals. Since the retainers are made of steel, a typical retainer design for large shaft seals has very large and heavy components, which creates issues for seal installation and replacement. Access to the seals and their retainers may be in a crowded space as well, further complicating seal replacement.

FIGS. 1, 2A, and 2B show the prior state of the art for multi-part seals. FIG. 1 is a front elevation view of a processor 10 having a wall 11 through which passes a shaft 26 for providing torque to an internal mechanism. A seal assembly 30 surrounds shaft 26 to prevent the migration of material into and from the internal space generally indicated at 19 in FIGS. 2A and 2B.

FIGS. 2A and 2B are cross sections each showing one minor variation of the configuration of a conventional seal assembly 30 encircling the shaft 26. These two configurations provide different axial positions for a seal unit 15 comprising seals 15a and 15b.

A mounting ring 27 permanently attached to wall 11 and with an axial dimension greater than that of wall 11, forms a periphery for the opening through which shaft 26 passes. Ring 27 has an inside diameter somewhat larger than the shaft 26 diameter, as FIGS. 2A and 2B show. Ring 27 strengthens and stiffens wall 11 in the vicinity of shaft 26.

Seal assembly 30 includes a seal 15 comprising flexible ring-type seal elements 15a and 15b, an inner retainer element 13, and an outer retainer element 12. Each of seal elements 15a and 15b, inner retainer element 13, and outer retainer element 12, have two or more segments to allow assembly to and disassembly from shaft 26, of the parts of seal assembly 30 necessary to replace seals 15a and 15b. An extension spring 15c presses the lip of seal element 15a or 15b against shaft 26 to insure good contact between them. The seal elements 15a and 15b are preferably similar and are intended to be installed with a small axial spacing between them, as FIGS. 2A and 2B show.

Retainer elements 12 and 13 serve to hold the individual seals 15a and 15b in place encircling shaft 26 and to prevent leakage around seals 15a and 15b to and from internal space 19. Each retainer ring 12 and 13 comprises two half circle segments. Cap screws 23 pass through holes at the end of one segment into threaded holes in the end of the other segment to hold the two outer retainer element 12 segments together to encircle shaft 26. Cap screws 29 pass through holes at the end of one segment of retainer 13 into threaded holes in the end of the other segment to hold the two inner retainer element 13 segments together to encircle shaft 26. (By the term “cap screw” is meant a fastener for machine parts, threaded at one end of its shank and held by threads tapped in a hole into which the cap screw is screwed. The end of the shank opposite the threads has a head with a feature such a hex shape or a square socket for applying torque to the shank.)

When replacing seals 15a and 15b, it is possible that removing only outer retainer element 12 will be necessary if seals 15a and 15b can be easily removed from their recess, and their recess does not require cleaning.

In configurations of both FIGS. 2A and 2B, inner retainer element 13 is fastened to the mounting ring 27 of processor 10 with cap screws 17, and the outer retainer element 12 is fastened to inner retainer element 13 with threaded rod fasteners 9. Retainer element 13 has an annular flange 22 and retainer element 12 also has an annular radial flange 23, both flanges 22 and 23 extending toward shaft 26. In an operating installation, retainer element flanges 22 and 23 retain seals 15a and 15b on the inside and the outside respectively in the desired axial position on shaft 26.

Inner retainer element 13 maintains the position of annular seals 16, allowing seals 16 to prevent migration of material along inner retainer element 13. A Zerk fitting 18 allows filling the space between and adjacent to seals 15a and 15b with grease after assembly is complete.

FIG. 2A shows a first orientation of retainer element 13 with the flange 22 adjacent to mounting ring 27. FIG. 2B shows a second, reversed orientation of retainer element 13 with the flange 22 spaced from mounting ring 27. In the FIG. 2B configuration, a spacer ring 14 comprising two half circle segments held in place by means not shown, space retainer elements 12 and 13 to place flanges 22 and 23 at the appropriate axial spacing to accommodate seals 15a and 15b. Thus, by orienting element 13 one way or the other, the seal assembly 30 can position seals 15a and 15b at two different axial positions on shaft 26 relative to housing wall 11.

The various components for this conventional seal assembly 30 are quite heavy for at least two reasons. In the first place, shaft 26 may have a diameter for large processors 10 of nearly 20 in., meaning that retainer elements 12 and 13 must have even larger maximum diameters. Secondly, the seal assemblies 30 must also be quite large in the axial dimension to accommodate the holes into which the tangential cap screws 23 and 29 thread. The retainer elements 12 and 13 may therefore weigh several tens of pounds.

The weight of the seal assembly 30 components becomes an issue during the periodic replacement of seals 15a and 15b that normal wear and deterioration requires. The working space for replacing seals 15a and 15b is often cramped. Yet when reattaching the retainer elements 13 and 12, they must be positioned so that the cap screws 17 and fasteners 9 precisely align with their respective holes. This is difficult with a heavy retainer element 13 while working in a cramped space. This situation makes replacement of seals 15a and 15b time-consuming and difficult.

### BRIEF DESCRIPTION OF THE INVENTION

A seal retainer assembly cooperates with a seal to prevent migration of material along a rotatable shaft passing through a wall. The seal encircles the shaft adjacent to the wall and has a surface facing away from the wall. The retainer assembly supports the shape and maintains the location of the seal to prevent this migration.

The retainer assembly has a number of individual parts designed to simplify disassembly and reassembly. An inner ring of the assembly is fastened to the wall and encircles the shaft to form an annular recess surrounding the periphery of the seal. A middle ring encircles the shaft, and has outside and inside diameters allowing the middle ring to fit into the annular recess between the inner ring and the seal.

An outer ring encircles the shaft, and has a flange projecting toward the shaft and contacting the surface of the seal facing away from the wall to retain the seal. The outer ring has a plurality of holes, each one in alignment with a hole in the middle ring.

A plurality of first fasteners attaching the outer ring to the middle ring. A plurality of second fasteners attached to the inner ring and engage a peripheral portion of the middle ring to press the middle ring toward the wall. When assembled, the middle ring encircles the outer periphery of the seal, and the outer ring's flange presses against the side of the seal facing away from the wall. Normally, the fasteners will comprise cap screws and threaded holes into which the cap screws fit.

The second fasteners preferably comprise cap screws in the threaded holes having engagement elements extending radially inwards past the inner edge of the inner ring, and engaging the outer periphery of the middle ring. For example, the engagement elements may comprise washers through which the cap screws pass.

One advantage of this design is that the rings comprise at least two circular arc sections having ends that contact another section in a self-aligning manner at interface points. Each interface point has an alignment feature such as a tongue and groove interface between adjacent section ends.

Ideally the ends of the middle ring sections are angularly displaced with respect to the ends of the outer ring sections. This arrangement allows the middle and outer rings to mutually maintain each other in the desired circular configuration.

Preferably, the seal comprises two similar seal elements to be installed with axial spacing between them, and middle ring has a flange projecting radially into the space between the seal elements.

A further embodiment of this invention comprises a retainer assembly having two rings.

A first ring is fastened to the wall and encircles the shaft to form an annular recess surrounding the periphery of the seal. A second ring encircles the shaft and has outside and inside diameters allowing at least a portion of the second ring to fit into the annular recess between the first ring and the seal. A plurality of fasteners attached to the first ring and external to the second ring, each engage a peripheral portion of the second ring to press the second ring toward the wall.

Preferably, the fasteners comprise cap screws. More preferably, the cap screw have washers on their shanks adjacent the heads thereof. The washers extend to overlap the second ring's periphery, to press the second ring toward the wall as the cap screws are tightened.

### DESCRIPTION OF THE DRAWINGS

FIGS. 1, 2A and 2B show the structure of prior art seal retainers.

FIGS. 3-8 show a version of an improved seal retainer structure 31.

For improved seal assembly 31:

FIG. 3 shows a front elevation view of seal retainer structure 31.

FIGS. 3A and 7 show a cross section at a first point of the periphery of seal retainer structure 31.

FIG. 3B shows a cross section at a second point of the periphery of seal retainer structure 31.

FIG. 3C is a cross section of the entire seal retainer structure.

FIG. 4 is a plan view of an inner retainer ring 33.

FIG. 4A is a section view of ring 33.

FIG. 5 is a plan view of a middle ring 37.

FIG. 5A is a section view of ring 37.

FIG. 6 is a plan view of an outer retainer ring 32.

FIG. 6A is a section view of ring 32.

FIGS. 7-8 show alternate versions of the mating surfaces of the ring 32 sections.

### DESCRIPTION OF THE INVENTION

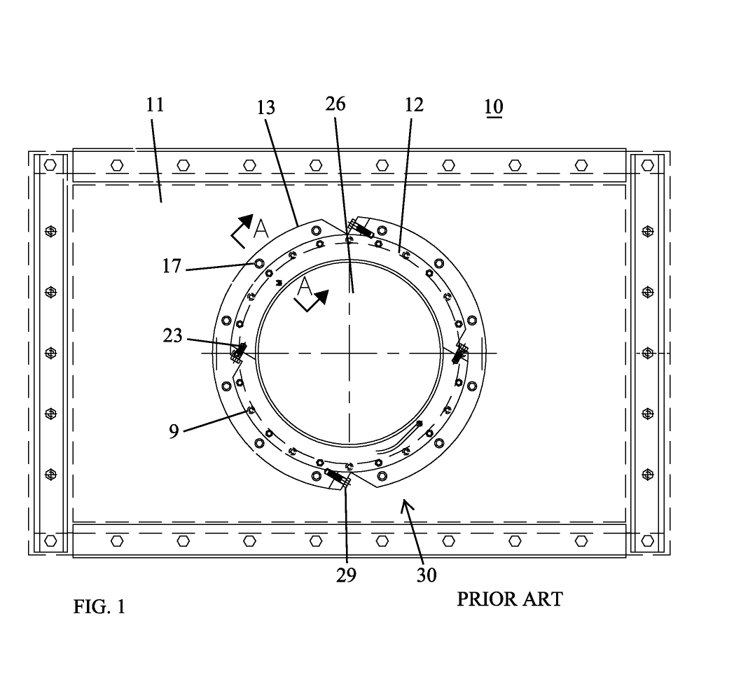

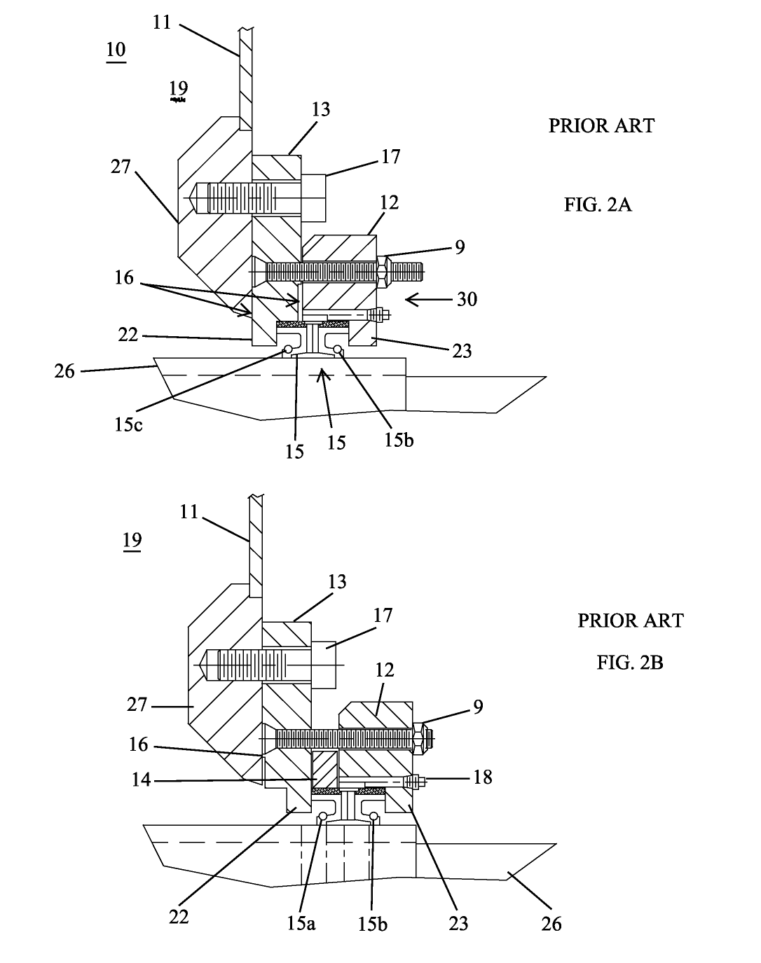

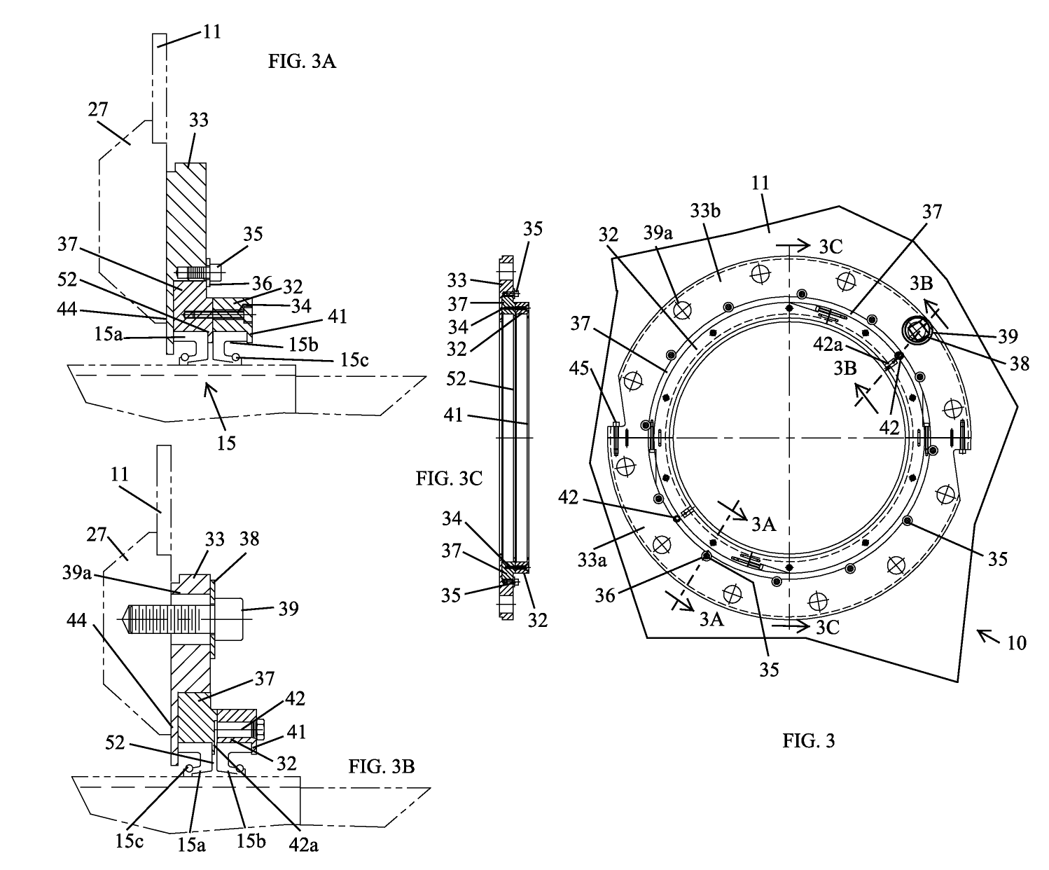

FIG. 3 shows a wall 11 of a housing having a shaft 26. The housing encloses an industrial process of the type for which migration of materials such as gasses, liquids, or particles along shaft 26 should not occur, precisely as with the embodiments shown in FIGS. 1, 2A and 2B.

To prevent such migration of materials along shaft 26, wall 11 has a seal retainer assembly 31 that is completely compatible with seals 15a and 15b now in use, and that has added advantages. Individual elements of assembly 31 are lighter than for the conventional assembly 30. Reassembly is easier because holes of a heavy outer ring 12 need not be simultaneously aligned with a number of individual fasteners 9. In addition, assembly 31 provides better stability for seals 15a and 15b.

Assembly 31 includes three major elements: an inner retainer ring 33, a middle spacer ring 37, and an outer retainer ring 32. Each of these three rings 33, 37, and 32 comprises at least two individual ring segments that mate to create a continuous ring 33, 37, or 32 after assembly is complete. Seal retainer assembly 31 holds conventional seals 15a and 15b in place with effectiveness and functionality equivalent to or better than the seal assembly 30 structure.

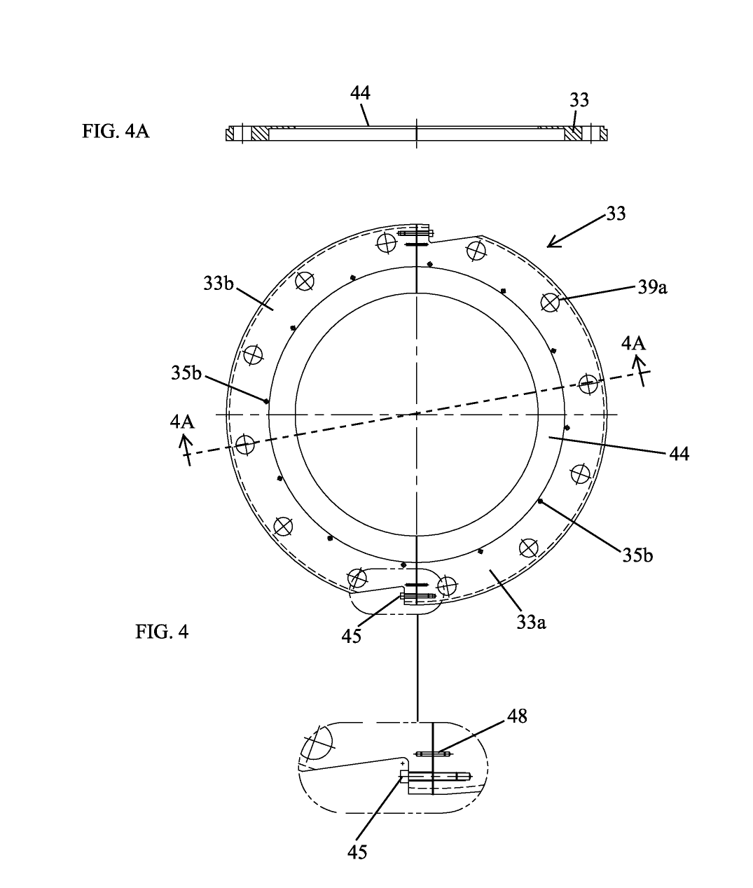

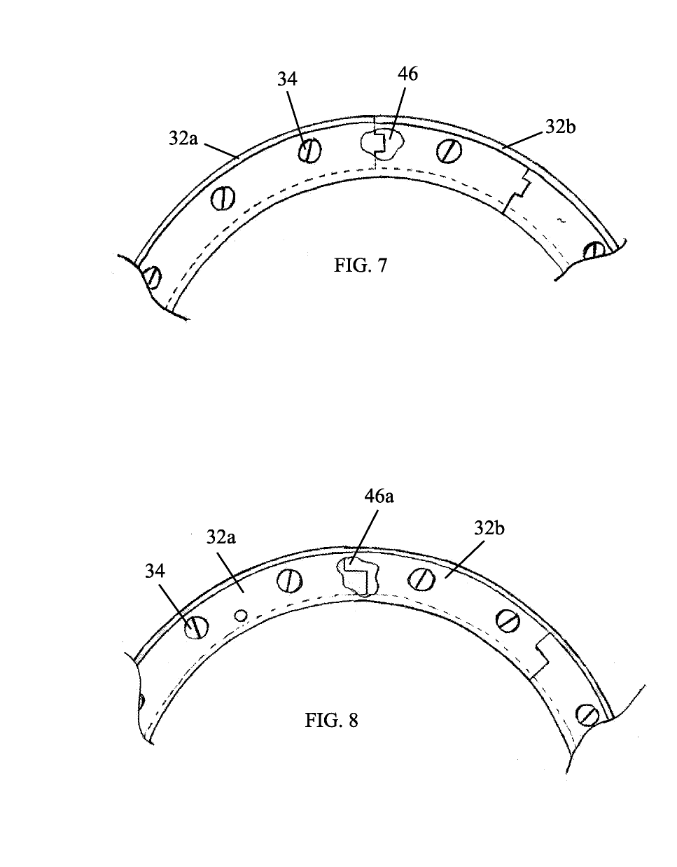

FIG. 3 and the cross section views of FIG. 3B show how cap screws 39 attach inner ring 33 to mounting ring 27. Cap screws 39 pass through washers 38 and holes 39a, see FIGS. 4 and 7 to attach ring 33 to ring 27. In general, inner ring 33 need not be removed when replacing seals 15a and 15b. FIG. 3C shows the entire retainer assembly in cross section, to provide a helpful perspective of the assembly's overall shape.

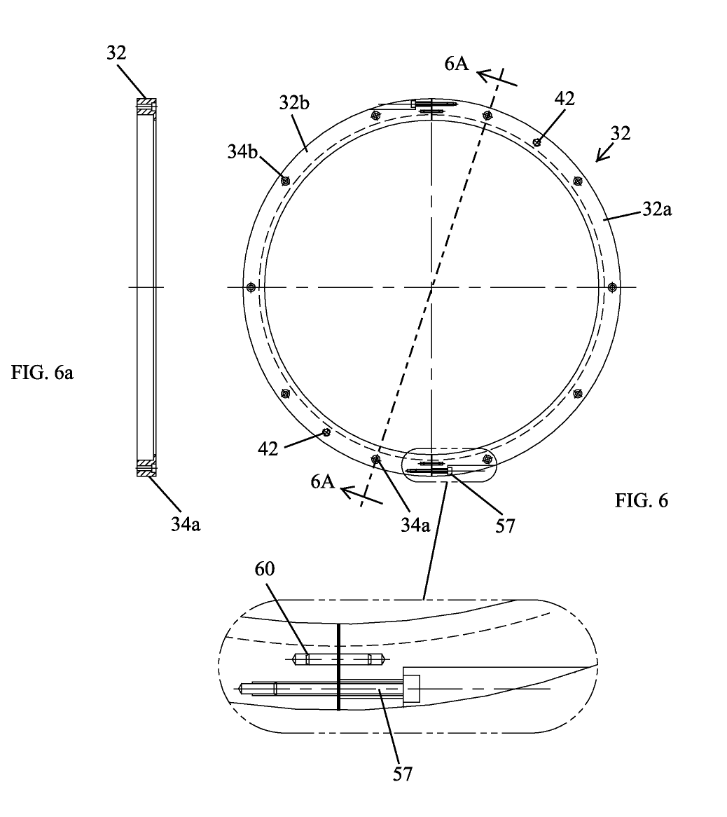

FIGS. 3B and 6 show two passages 42 in outer ring 32 for injecting grease into a grease space formed by seal elements 15a and 15b and shaft 26. Middle ring 37 has two troughs 42a that align with passages 42 to provide a route allowing grease to flow to the grease space. Outer ring 32 must be angularly positioned with middle ring 37 to align passages 42 with troughs 42a.

In one preferred embodiment, inner ring 33 comprises two semicircular segments 33a and 33b fastened to each other with cap screws 45. FIG. 4 shows tangentially oriented cap screws 45 that fasten two inner ring half segments 33a and 33b to each other to form inner ring 33. Dowels 48 shown in the detail of FIG. 4 assist in accurately aligning segments 33a and 33b to each other. Ring 33 may also comprise three or more segments held together with screws 45 and aligned with dowels 48.

Ring 33 has an interior flange 44, shown best in FIGS. 3A, 3B, 4, and 4A, for axially aligning and retaining seal 15a. The outwardly facing surface of flange 44 defines an inner surface of an annular recess that receives ring 37 and seal 15a. FIG. 3B shows how inner ring 33 attaches to mounting ring 27 with cap screws 39 that pass through holes 39a and when tightened, press washers 38 against ring 33 to clamp same in place.

The substantial amount of clearance space between individual cap screws 39 and holes 39a allows the installer to accurately center ring 33 with respect to shaft 26. Once inner ring 33 is centered and cap screws 39 tightened, there normally will be no reason to remove and then later realign inner ring 33. Accurate centering of inner ring 33 assures accurate centering of the entire assembly 31 and rings 15a and 15b with respect to shaft 26. Three temporary shims placed between the inner edge of flange 44 and shaft 26 may aid in centering ring 33. Sealant, O-rings, or other types of gasket material between inner ring 33 and mounting ring 27 prevents migration of material through this area.

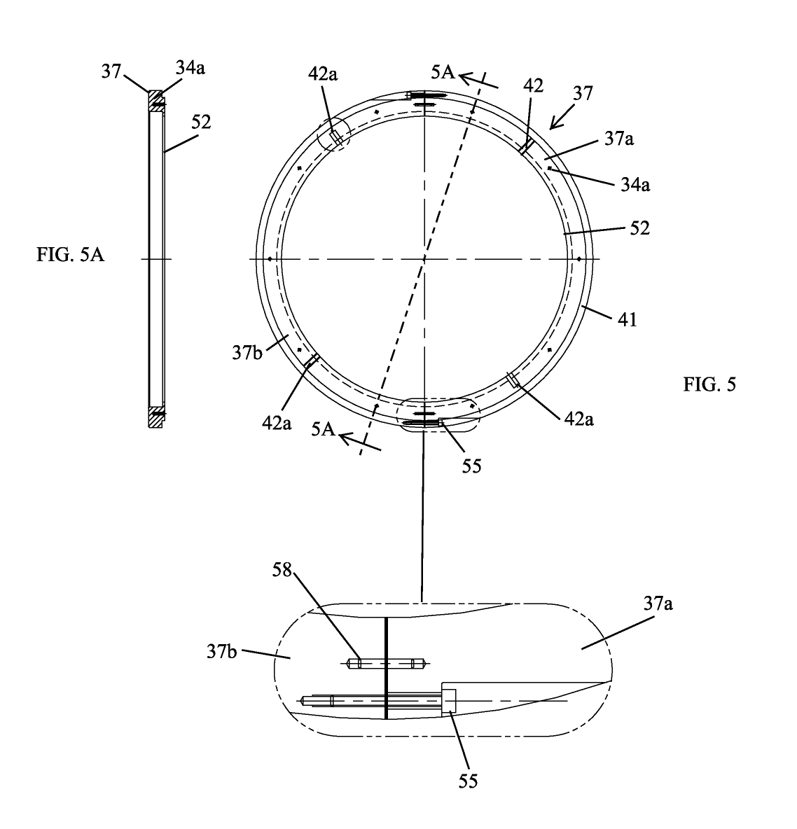

The middle retaining ring element 37 comprises two or more segments 37a, 37b shown assembled in the front projection view by FIG. 5. Cap screws 55 bolt segments 37a, 37b together to form element 37, with dowels 58 providing for accurate alignment of the segments 37a, 37b ends. The outer diameter of ring element 37 should fit snugly into the annular recess of ring element 33. The inner diameter of ring element 37 should accommodate the outer diameter of seal element 15a.

Ring element 37 has a number of holes 34b threaded to receive cap screws 34. While ring element 37 is shown with only two segments 37a, 37b are show in FIG. 5, other numbers, such as four or six segments are also possible, each having alignment features 46 with the two adjoining segments.

FIG. 5 and the inset therein shows at the end of each segment 37a, 37b, an alignment feature comprising a dowel 58 that fits into holes of the segment 37a, 37b ends. Other types of interface structures are also possible. For example, FIG. 8 shows the interface as simple overlapping projections at 46a. The interfacing surfaces of segments 37a and 37b need not align with the axis of shaft 26, but may lie transverse to that axis in an overlapping relationship. A further benefit of the tongue and groove structure for interface features 46 is more effective resistance to migration of lubricating grease forced into the cavity between the seals 15a and 15b and ring 37 than a simple butt interface furnishes.

Middle ring element 37 is held in place by a number of cap screws 35 that fit into threaded holes 35b (FIG. 4) angularly distributed around inner ring 33. FIG. 4 shows eight holes 35b at angular intervals of 45°. Each cap screw 35 passes through an engagement element preferably comprising a washer 36 that extends radially inwards past the inner edge of inner ring 33 to engage ring 37. When cap screws 35 are tight, washers 36 press against the outer periphery of the middle ring 37 outwardly facing surface.

Ring 37 should have a peripheral thickness provided in FIG. 5 by a peripheral recess 41 that projects slightly past the outer face of inner ring 33 to allow washers 36 to engage ring 41 and force ring 37 against flange 44. A thicker ring 37 may have an annular projection that aligns with the outer face of inner ring 33 allowing washers 36 to engage and press on ring 37, forcing ring 37 toward wall 11.

Importantly, ring 37 has an inwardly extending annular flange 52 best seen in FIGS. 3A and 5A. Flange 52 serves to retain the outer edge of seal element 15a and the inner edge of seal element 15b, to help maintain seal elements 15a and 15b in the desired shape and axial position.

The outer ring element 32 that FIGS. 3A, 3B, 6, and 6A show, preferably comprises two or more similar segments 32a, 32b, each in the general shape of a circular arc. Segments 32a and 32b have a number of equally-spaced holes 34a that are countersunk to receive cap screws 34 by which outer ring segments 32a, 32b attach to segments 37a and 37b of middle ring element 37. An exterior and inwardly directed flange 42 on ring element 32 provides axial alignment and retention for seal 15b. FIGS. 3A and 7 show how flange 42 of outer ring 32 provides axial alignment and retention for the outer edge of seal element 15b.

Each segment 32a, 32b has on each end thereof, an attachment feature comprising a pair of cap screws 57 and an alignment feature comprising dowels 60. The detail view of FIG. 6 shows these features in more detail, which may be similar to the attachment and alignment features for middle ring element 37. These dowels 60 fit into holes on the ends of adjacent segment 32a or 32b to assist the ends thereof into alignment.

Other types of alignment features are possible. In FIG. 7, the alignment features on outer ring segments 32a, 32b comprise a tongue and groove 56 interface but other types of interface shapes are also possible, such as the mating projections 46a in FIG. 8. Rings 33 and 37 may also use such alignment features. If ring elements 33, 37, or 32 comprise more than two segments, each segment should have alignment features that interface with the two adjoining segments.

FIGS. 3A and 7 show means for fastening ring elements 33, 37, and 32 to each other and to mounting ring 27. Cap screws 34 directly bolt outer ring 32 to middle ring 37. This can be done before placing the elements of outer ring 32 and middle ring 37 in the position adjacent to inner ring 32, which simplifies the assembly process. Attachment elements comprising for example cap screws 35 thread into holes near the inner periphery of inner ring 33 to press washers 36 against peripheral segments 37a, 37b of middle ring 37 within ring 33 and against flange 44. Middle ring 37 can assume any angular position with respect to inner ring 33, again simplifying assembly.

The alignment interfaces 56 of outer ring 32 should be angularly displaced with respect to the alignment interfaces 46 of middle ring 37. In this way, ring segments 32a, 32b and 37a, 37b can be connected to each other to mutually maintain the circular shape of the other.

FIGS. 3B and 6 show two passages 42 in outer ring 32 for injecting grease into a grease space formed by seal elements 15a and 15b and shaft 26. Middle ring 37 has two troughs 42a that align with passages 42 to provide a route allowing grease to flow to the grease space. Outer ring 32 must be angularly positioned with middle ring 37 to align passages 42 with troughs 42a.

Assembly of seal assembly 31 involves first assembling inner ring 33 by atttaching the two inner ring halves 33a and 33b to each other using cap screws 45, see FIG. 4. A cap screw 45 passes though an individual hole at one end of each ring half 33a and 33b, into a threaded hole at the end of the other ring half 33a or 33b.

As previously explained, cap screws 39 attach inner ring 33 to housing 11 typically more or less permanently and with accuracy that assures precise centering of the entire assembly 31 on shaft 26. When replacing seal 15, rings 32 and 37 are detached and the old seal 15 is removed. Then first seal element 15a is assembled on shaft 26 by gluing or otherwise attaching ends of seal strip material to each other, and spring 15c is installed. Seal 15a is then pushed into the position shown in FIGS. 3A and 3B. Using cap screws 55 and dowels 58, middle ring segments 37a, 37b are bolted to each other around shaft 26 and slid against seal element 15a within the annular recess of inner ring 33. Flange 52 should be spaced away from the flange 44 on ring 33. The larger annular space between ring 33 and seal section 15 compared to the prior art, simplifies reassembly.

Next, seal element 15b is assembled around shaft 26 and a spring element 15c installed as shown in FIGS. 3A and 3B. Seal element 15c is then slipped along shaft 26 to press against flange 52. Ring 32 is then assembled on shaft 26 using cap screws 57 and dowels 60 and shifted into position, to match the configuration in FIGS. 6 and 6A with holes 34b aligned with holes 34a in ring 37. Cap screws 34 are then inserted into holes 42b and tightened to hold outer ring 32 against middle ring 37. It may well be than none of the cap screws 34 and 35 should be tightened until all engage their individual threaded holes.

The relatively small and light segments 37a, 37b and 32a, 32b are quite easy to maneuver and position for installation, even in cramped spaces. Further, the machining cost and difficulty is likely reduced since the layered thin rings 37 and 32 replace the relatively larger blocks of steel of the conventional designs in FIGS. 1, 2A and 2B.

When seals 15a and 15b replacement is necessary, it is relatively easy to detach and disassemble rings 32 and 37, and remove them from shaft 26. After new seals 15a and 15b have been mounted on shaft 26, the relatively small and light segments 32a, 32b and 37a, 37b are easy to quickly and easily reinstall.

In some installations, only a single seal element 15a need be retained. In such a case, outer ring 32 is unnecessary. Flange 52 then serves to retain the outer edge of inner seal element 15a. In that case, flange 52 might extend closer to shaft 26.

What I claim is:

1. A retainer assembly for a seal preventing migration of material along a rotatable shaft passing through a wall, said seal encircling the shaft adjacent to the wall and having a surface facing away from the wall, said retainer comprising:
a) an inner ring fastened to the wall and encircling the shaft to form an annular recess surrounding the periphery of the seal;
b) a middle ring encircling the shaft with outside and inside diameters allowing the middle ring to fit into the inner ring's annular recess between the inner ring and the seal;
c) an outer ring encircling the shaft, and having a flange projecting toward the shaft and contacting the surface of the seal facing away from the wall to retain the seal said outer ring having a plurality of holes each one in alignment with a hole in the middle ring;
d) a plurality of first fasteners attaching the outer ring to the middle ring; and
e) a plurality of second fasteners attached to the inner ring, each engaging a peripheral portion of the middle ring to press the middle ring toward the wall.

2. The retainer assembly of claim 1, wherein the fasteners comprise threaded holes and cap screws.

3. The retainer assembly of claim 2, wherein the second fasteners comprise areas of the inner ring containing angularly distributed threaded holes, and cap screws in the threaded holes having engagement elements extending radially inwards past the inner edge of the inner ring, and engaging the outer periphery of the middle ring.

4. The retainer assembly of claim 3, wherein the engagement elements comprise washers through which the cap screw shanks pass.

5. The retainer assembly of claim 1, wherein each of the rings comprises at least two circular arc sections having ends that contact another section.

6. The retainer assembly of claim 5, wherein the circular arc sections of at least one of the middle and outer rings have at the interface points thereof an alignment feature.

7. The retainer assembly of claim 6, wherein the alignment feature comprises a tongue and groove interface between adjacent section ends.

8. The retainer assembly of claim 6, wherein the alignment feature comprises a dowel pin within holes at adjacent section ends.

9. The retainer assembly of claim 5, wherein the ends of the middle ring sections are angularly displaced with respect to the ends of the outer ring sections.

10. The retainer assembly of claim 8, wherein the seal comprises two similar seal elements to be installed with axial spacing between them, and the middle ring has a flange projecting radially into the space between the seal elements.

11. The retainer assembly of claim 1, wherein the seal comprises two similar seal elements to be installed with axial spacing between them, and the middle ring has a flange projecting radially into the space between the seal elements.

12. A retainer assembly for a seal preventing migration of material along a rotatable shaft passing through a wall, said seal encircling the shaft adjacent to the wall and having a surface facing away from the wall, said retainer comprising:
a) a first ring fastened to the wall and encircling the shaft to form an annular recess surrounding the periphery of the seal;
b) a second ring encircling the shaft with outside and inside diameters allowing at least a portion of the second ring to fit into the annular recess between the first ring and the seal; and
c) a plurality of fasteners attached to the first ring and external to the second ring, each engaging a peripheral portion of the second ring to press the second ring toward the wall.

13. The retainer assembly of claim 12, wherein the fasteners comprise cap screws.

14. The retainer assembly of claim 13, wherein the fasteners comprise washers on the cap screw shanks adjacent the heads thereof, and extending to overlap the second ring's periphery.
